(19) United States
(12) Patent Application Publication
(10) Pub. No.: US 2004/0207218 A1
(43) Pub. Date: Oct. 21, 2004

(54) Tube stuffer

(76) Inventor: Clifford Lamar Revell, Clermont, FL (US)

Correspondence Address: Timothy L. Hughes, Esq., Gray Robinson, P.A., Suite 1400, 301 East Pine Street, Orlando, FL, 32801, US

(21) Appl. No.: 10/799,698

(22) Filed: Mar. 15, 2004

Related U.S. Application Data
(60) Provisional application No. 60/455,428, filed on Mar. 18, 2003.

(51) Int. Cl. B25J 1/00

(52) U.S. Cl. 294/19.1

(57) ABSTRACT

An invention consisting of a stationary rod for holding rolled or bagged paper materials, which rod is surrounded by an extendable sleeve and butt plate assembly to discharge rolled materials resting on the end of the stationary rod intended to provide a newspaper carrier or other individual utilizing a motor vehicle for delivery of newspapers or other rolled materials to quickly place the rolled materials into receiving containers outside of the vehicle while occupying the driver's seat of the vehicle.

### CROSS-REFERENCE TO RELATED APPLICATION

This application claims the benefit of provisional application No. 60/455,428's filing date of Mar. 18, 2003.

### BACKGROUND OF THE INVENTION

1. Field of the Invention

This invention relates to a tool designed to aid driver's of motor vehicles in the delivery of rolled or bagged newspapers into a newspaper tube or container.

2. Background of the Invention and Related Art

The typical newspaper carrier of today is not the local “newspaper boy” with a bag of papers slung over his shoulder known in yesteryear. With increasing circulation and expanding geographic coverages, newspaper companies of all sizes have increasingly begun using newspaper tubes to facilitate paper delivery by motor vehicle. These tubes are either mounted in conjunction with the subscriber's mailbox or on a standalone post. Carriers typically pull their vehicle up to a newspaper tube and insert a newspaper from either side of the vehicle, depending upon the location of the tube. The newspaper tube is frequently located on the passenger's side of the vehicle. This makes it both difficult and time consuming for the carrier to place the newspaper into the tube.

For many of today's newspaper carriers, newspaper delivery is a way to earn extra income on top of what they make at their “regular” job. The fact that most newspapers are delivered early in the morning enables these carriers to complete their route and still make it to their “regular” job on time. This presumes, of course, the carrier can complete his route in a timely fashion. The typical carrier with a motor vehicle delivery route will cover many miles and place hundreds of papers into tubes each morning. The amount of time it takes to place each newspaper into a tube is critical to the overall time it takes to complete the route.

When a carrier pulls up to a tube located on the passenger's side of the vehicle, he must put the vehicle in park, climb across the seat (and any newspapers on the seat), and put the newspaper through the open window into the tube. He then climbs back into the driver's seat, puts the car back into drive, and resumes delivery on the route. With the advent of mandatory seat belt laws in many states, the carrier may also be required to unbuckle his seat belt to allow him to reach through the passenger's open window, then re-buckle before proceeding to the next tube. Each of these steps, necessary to place a paper in a passenger-side tube, are repeated over and over each morning, costing the carrier precious time.

Passenger-side tube delivery is sometimes made even more difficult when obstructions in front of the tube prevent the carrier from driving his vehicle close enough to place the newspaper in the tube. In these instances the carrier must exit the vehicle and physically walk around the vehicle to the tube to accomplish delivery.

The Starz U.S. Pat. No. 3,990,735 describes a newspaper delivery aid utilizing a cylinder containing an internal plunger mechanism, mounted on a handle. However, the Starz design relies on the plunger to eject the rolled paper from the delivery cylinder. As a result, it requires the carrier to adjust the newspaper roll to fit the delivery cylinder prior to delivery, which requires additional time and limits the size of newspaper capable of being delivered. Furthermore, if the newspaper roll is ill-fitted into the delivery cylinder it can resist ejection by the plunger and may wrinkle or tear. The Starz design is also significantly more complex than the present invention and as a result, would require a more labor-intensive manufacturing process as well as more potential for parts to malfunction or break.

### SUMMARY OF THE INVENTION

It is an objective of the present invention to provide newspaper carriers with motor vehicle routes a tool that will enable the carrier to quickly place rolled newspapers into newspaper tubes without having to move out of the driver's seat or exit their vehicle. Design features allowing this object to be accomplished include a stationary suspension rod inserted in a movable outer sleeve which sleeve has an attached butt plate at one end which is utilized to push and deliver rolled newspapers off of the end of the stationary rod. Benefits associated with reaching this objective include substantial time savings in newspaper delivery and simplified, more convenient delivery.

It is an objective of the present invention to provide newspaper carriers with motor vehicle routes a tool which can quickly deliver any size of rolled newspaper. The use of a suspension rod rather than a random sized receiving cylinder, gives the newspaper carrier a more functional and versatile tool. A major advantage of this tool is that the carrier can be confident the tool can be used to deliver any and all bagged or rolled newspapers, regardless of size.

It is still another objective of the present invention to provide newspaper carriers with motor vehicle routes a tool which is easy to use, requiring a minimal amount of newspaper handling. The design feature allowing this objective to be accomplished is the uncontained suspension rod—free from the limiting dimensions of any surrounding delivery cylinder—upon which the newspaper is placed. An advantage of this design is that it will save carriers time by never having to re-roll or otherwise manipulate a newspaper to fit within a delivery cylinder or other size constrained delivery mechanism.

It is yet another object of the present invention to provide newspaper carriers with motor vehicle routes a tool which is inexpensive to manufacture and maintain. Design features allowing this object to be achieved include the fact that the tool is composed of few parts which work together in a simple operation, requires little or no maintenance, and uses components which can be made of any number of readily available materials. Benefits associated with reaching this objective include reduced production costs, increased availability, no maintenance and related upkeep costs and longevity of service.

### BRIEF DESCRIPTION OF THE DRAWINGS

The invention, together with the other objects, features, aspects and advantages thereof will be more clearly understood from the following in conjunction with the accompanying drawings.

Three sheets of drawings are provided. Sheet one contains FIGS. 1, 2 and 3. Sheet two contains FIGS. 4 and 5. Sheet three contains FIGS. 6 and 7.

FIG. 1 is a perspective view of the Tube Stuffer assembly.

FIG. 2 is a front view of the Tube Stuffer assembly.

FIG. 3 is a side view of the Tube Stuffer assembly.

FIG. 4 is a side view of the Tube Stuffer assembly showing the insertion sleeve and butt plate in the retracted position with a rolled newspaper hanging on the suspension rod.

FIG. 5 is a side view of the Tube Stuffer assembly, similar to FIG. 4, but showing the insertion sleeve and butt plate in the forward position with a rolled newspaper being delivered into a newspaper receiving container.

FIG. 6 is a longitudinal cross sectional view of FIG. 3, taken at section VI-VI of FIG. 3, with the sleeve and butt plate in the fully retracted, proximal position.

FIG. 7 shows a modified form of the Tube Stuffer assembly wherein the suspension rod has a bore extended therethrough, the butt plate has a spoked configuration about its bore, the end cap has been removed, and the proximal portion of the suspension rod is bent down at an angle to facilitate the carrier's use and manipulation of the Tube Stuffer.

### DETAILED DESCRIPTION OF THE PREFERRED EMBODIMENT

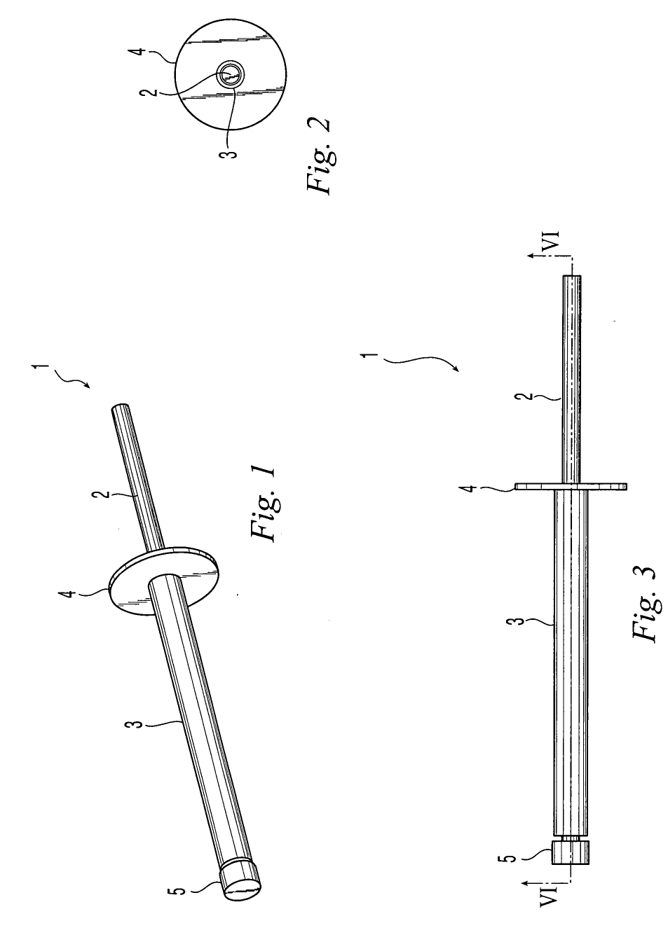

FIG. 1 is a perspective view of the Tube Stuffer assembly 1. The Tube Stuffer assembly 1 comprises a movable, external sleeve 3 having a bore extended longitudinally therethrough, a suspension rod 2 which passes through the external sleeve 3, a butt plate 4 attached to the distal end of the external sleeve 3 and an end cap 5 secured to the proximal end of the suspension rod 2. The external sleeve 3 is generally shorter than the suspension rod 2 and passes through the bore in butt plate 4. Butt plate 4 is attached to the distal end of the external sleeve 3 and the two are permanently attached to one another to form essentially one functional unit. The suspension rod 2 is inserted into the external sleeve 3 and attached butt plate 4 such that the external sleeve 3 and butt plate 4 are able to travel back and forth freely along the longitudinal axis of the suspension rod 2.

FIG. 2 is a front view of the Tube Stuffer assembly 1. It shows the butt plate 4, external sleeve 3, and suspension rod 2 positioned about a common longitudinal axis. While the butt plate 4, external sleeve 3, and suspension rod 2 are all depicted as being circular in shape, the functionality of this invention is not dependent upon nor limited to this shape alone.

FIG. 3 depicts the side view of the Tube Stuffer assembly 1. Suspension rod 2 extends through the longitudinal bore in external sleeve 3. Suspension rod 2 extends the desired distance beyond the distal face of the butt plate 4. Butt plate 4 is shown at the distal end of insertion sleeve 3. End cap 5 is shown at the proximal end of suspension rod 2.

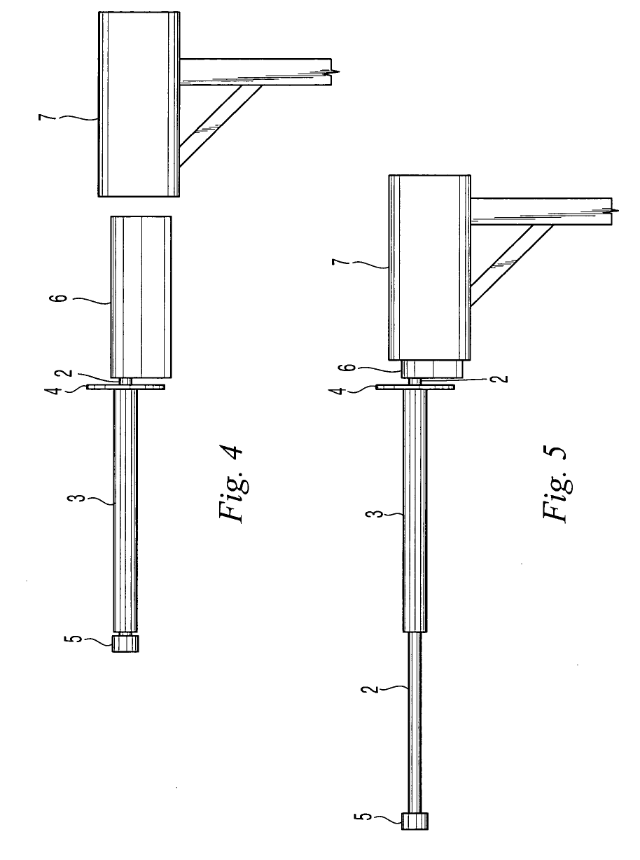

FIG. 4 is a side view of the Tube Stuffer assembly 1 with a rolled newspaper 6 resting on the suspension rod 2. The external sleeve 3 and attached butt plate 4 are shown in the retracted position, towards the proximal end of the suspension rod 2. The length of the suspension rod 2 is such that when a rolled newspaper 6 is slid on the suspension rod 2's distal end, the user can, while sitting in the driver's seat of the automobile, extend his or her arm holding the proximal end of the suspension rod 2 and the rolled newspaper 6 will extend through the open window or door of the vehicle on the opposite side of the automobile and be within close proximity to the newspaper receiving container 7. After the rolled newspaper 6 is placed on the distal end of the suspension rod 2, the Tube Stuffer assembly 1 is directed by the user towards the newspaper receiving container 7.

FIG. 5 is a side view of the Tube Stuffer assembly 1 demonstrating how the Tube Stuffer assembly 1 is used to quickly and efficiently place a rolled newspaper 6 into a newspaper receiving container 7. The suspension rod 2 is manufactured to a length to enable the newspaper carrier to slide the external sleeve 3 towards the proximal end of the suspension rod 2, place the rolled newspaper 6 on the distal end of the suspension rod 2, and extend the distal end of the suspension rod 2 through the window or door of the vehicle the carrier is driving to a close proximity to the newspaper receiving container 7, all while remaining in the driver's seat of the motor vehicle. The carrier then places one hand on the proximal end of the suspension rod 2 while using his other hand to slide the external sleeve 3 towards the distal end of the suspension rod 2. The butt plate 4 prevents the rolled newspaper 6 from riding up on the insertion sleeve 3 and pushes the rolled newspaper 6 into the newspaper receiving container 7 from the distal end of the suspension rod 2. The rolled newspaper 6 is pushed off of the distal end of the suspension rod 2 by the butt plate 4 into the newspaper receiving container 7.

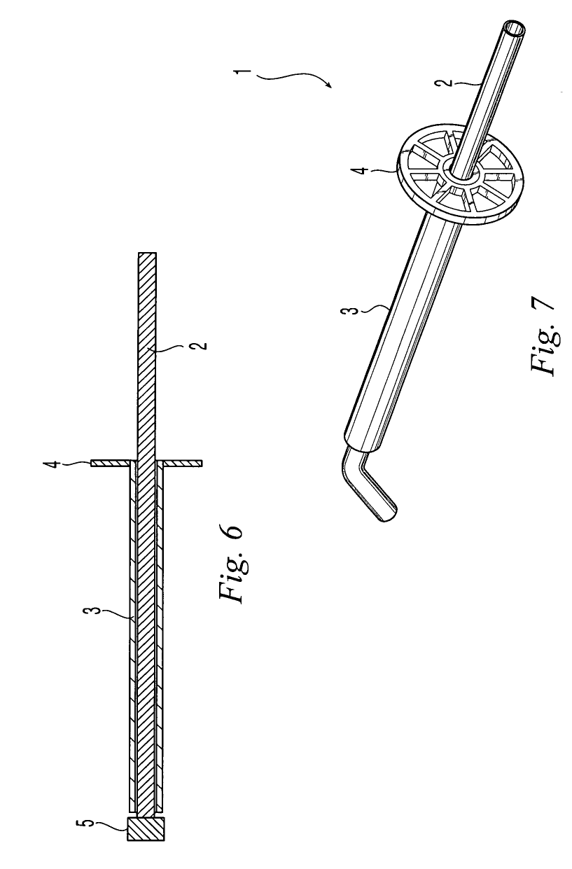

FIG. 6 is a longitudinal cross-sectional view of FIG. 3, taken at section VI-VI of FIG. 3 with the external sleeve 3 in the fully retracted, proximal position that it would be in prior to placing a newspaper on the distal end of suspension rod 2. FIG. 6 also depicts the longitudinal bore within the external sleeve 3 and the suspension rod 2 within.

FIG. 7 shows a perspective view of a modified form of the Tube Stuffer assembly 1. The proximal end of the suspension rod 2 is bent in a downward direction to create a more ergonomically friendly “pistol grip” configuration. This preferred embodiment facilitates the carrier's use and manipulation of the Tube Stuffer assembly 1. FIG. 7 also depicts the suspension rod 2 with a longitudinal bore and the butt plate 4 with a spoked configuration. Each of the variations depicted in FIG. 7 are intended to be non-limiting alternatives.

### Drawing Item Index

1 Tube Stuffer assembly

2 suspension rod

3 external sleeve

4 butt plate

5 end cap

6 rolled newspaper

7 newspaper receiving container

I claim:

1. A tool designed to aid an individual operating a motor vehicle in the delivery of rolled paper materials roughly the length and width of a newspaper into roadside newspaper receiving containers, comprising:
an external sleeve having a bore extended longitudinally therethrough;
a stationary suspension rod, said stationary suspension rod inserted along the longitudinal axis through the bore in the external sleeve, with said external sleeve remaining free to slide along the longitudinal axis of the suspension rod, said suspension rod being of a length sufficient to enable the user to place the distal end of the suspension rod through an open window, door or other similar opening of the user's vehicle to close proximity to a newspaper receiving container on the opposite side of the vehicle, all while occupying the driver's seat of the motor vehicle;
a butt plate with a bore sized to admit said external sleeve, with the distal end of said external sleeve passing through and secured to the butt plate so that the distal face of said external sleeve is flush with the distal face of the butt plate, with said external sleeve and butt plate assembly being shorter in length than the suspension rod as necessary to allow the distal end of the suspension rod to be inserted longitudinally into the center of a rolled newspaper such that the rolled paper will rest on the suspension rod between the butt plate and the distal end of the suspension rod; and
an end cap secured to the proximal end of the suspension rod, said end cap being of sufficient size to prevent the external sleeve from slipping off the proximal end of the suspension rod.

2. The tool as recited in claim 1, wherein the suspension rod has a bore extended therethrough.

3. The tool as recited in claim 1 wherein said end cap is removed and the proximal portion of said suspension rod is bent down at an angle to facilitate the carrier's holding and manipulation of the tool.

4. The tool as recited in claim 3, wherein the suspension rod has a bore extended therethrough.
